(19) United States
(12) Patent Application Publication
(10) Pub. No.: US 2012/0136851 A1
(43) Pub. Date: May 31, 2012

(54) Method of Sorting Applications for Server and Related Communication Device

(76) Inventors: Ju-Ting Yang, Taoyuan County (TW); Yin-Yeh Tseng, Taoyuan County (TW)

(21) Appl. No.: 13/276,330

(22) Filed: Oct. 19, 2011

Related U.S. Application Data
(60) Provisional application No. 61/417,320, filed on Nov. 26, 2010.

(30) Foreign Application Priority Data
Apr. 19, 2011 (TW) 100113521

(51) Int. Cl. G06F 17/30

(52) U.S. Cl. 707/722; 707/E17.014

(57) ABSTRACT

A method of sorting applications for a server is disclosed. The method includes receiving a request message, performing a search procedure and generating a search result, and sorting the applications in the search result according to a criterion.

### CROSS REFERENCE TO RELATED APPLICATIONS

This application claims the benefit of U.S. Provisional Application No. 61/417,320 filed on Nov. 26, 2010 and entitled “Sorting Mechanism Applied In Application Store”, the contents of which are incorporated herein by reference.

### BACKGROUND OF THE INVENTION

1. Field of the Invention

The present invention relates to a method of sorting applications for server and related communication device capable of sorting applications.

2. Description of the Prior Art

Open Mobile Alliance (OMA) is the focal point for the development of mobile service enabler specifications, which support the creation of interoperable end-to-end mobile services. OMA drives service enabler architectures and open enabler interfaces that are independent of the underlying wireless networks and platforms. OMA creates interoperable mobile data service enablers that work across devices, service providers, operators, networks, and geography.

A concept of online application stores, such as Apple App store and Google Android market, is provided to offer downloadable application to users. Users can browse the application store and download the application they want. The application might be free, or with a price depending on the application itself.

Currently, in OMA (Open Mobile Alliance), TAS (Telco's Application Store) work item is establishing a unified framework of Application Store which integrates all the stages of application development support, application distribution, application sales and so on.

### SUMMARY OF THE INVENTION

It is therefore an object of the present invention to provide a method of sorting applications for server and related communication device.

The present invention discloses a method of sorting applications for a server, the method including receiving a request message, performing a search procedure according to the request message and generating a search result including information of applications, and sorting the applications indicated in the search result according to a criterion.

The present invention further discloses a method of sorting applications for a mobile device, the method including receiving a search result including information of applications from a server, and sorting the applications indicated in the search result according to a criterion, and displaying the sorted search result.

The present invention further discloses a server for performing applications sorting, the server including a storage unit, for storing a program code corresponding to a processing method, and a processor, coupled to the storage unit, for processing the program code to perform the processing method, wherein the processing method includes receiving a request message, performing a search procedure according to the request message and generating a search result including information of applications, and sorting the applications indicated in the search result according to a criterion.

The present invention further discloses a communication device for performing applications sorting, the communication device including a storage unit, for storing a program code corresponding to a processing method, and a processor, coupled to the storage unit, for processing the program code to perform the processing method, wherein the processing method including receiving a search result including information of applications from a server, and sorting the applications indicated in the search result according to a criterion, and displaying the sorted search result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary wireless communication system.

FIG. 2 is a schematic diagram of a wireless communication device according to an embodiment of the present invention.

FIG. 3 is a flow chart of an exemplary process.

FIG. 4 is a flow chart of an exemplary process.

### DETAILED DESCRIPTION

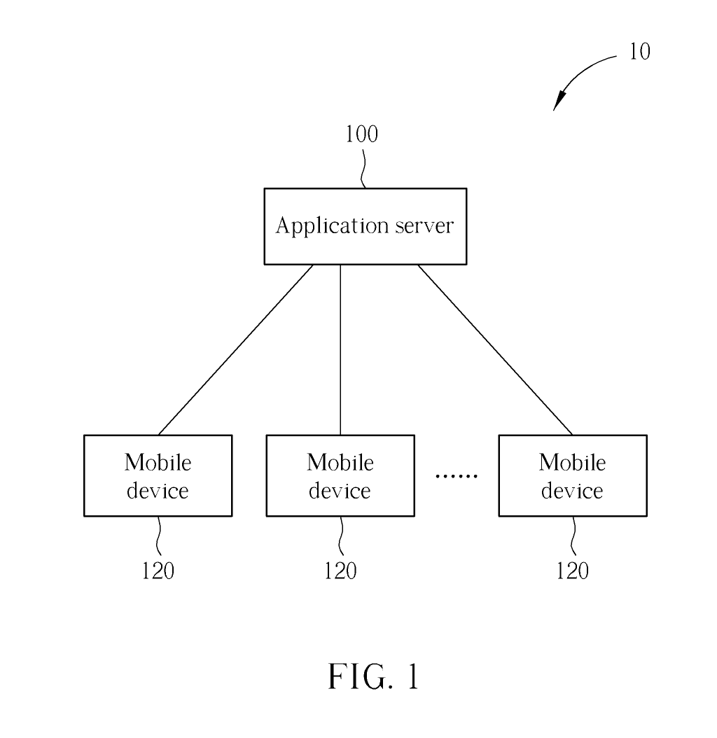

Please refer to FIG. 1, which is a schematic diagram of an exemplary wireless communication system 10. The wireless communication system 10 conforms to the open mobile alliance (OMA), working among different devices, service providers, operators, networks, and geography. The wireless communication system 10 includes an application server 100 and multiple mobile devices 120. The application server 100 is provided to offer downloadable applications for users of the multiple mobile devices 120. The mobile device 120 may be a mobile phone, a computer, a music player and so on. The users of the mobile devices 120 may download required applications from the application server 100 through an application list displayed by the mobile device 120. Categories of the applications may include game, traveling, product, entertainment, book, education, etc., which may be free or with a price depending on the application itself.

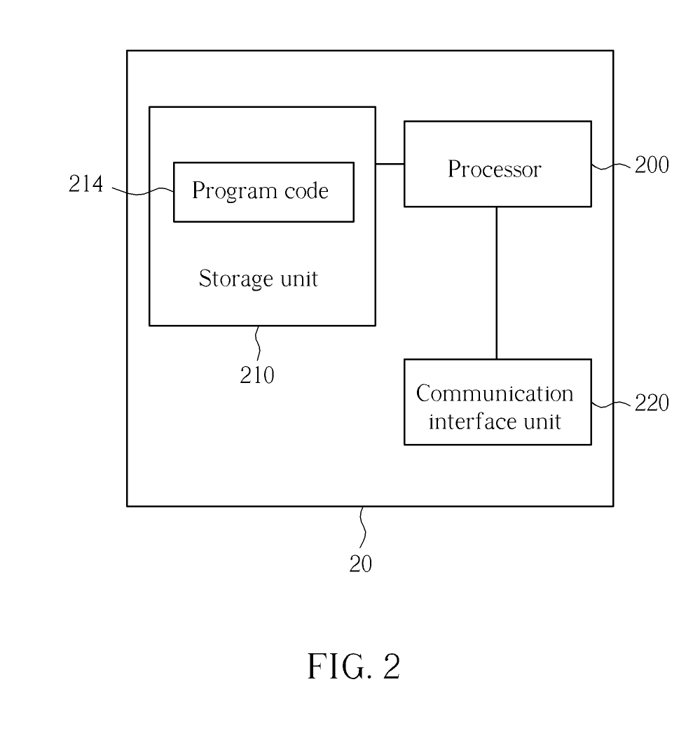

Please refer to FIG. 2, which is a schematic diagram of a communication device 20 according to an embodiment of the present invention. The communication device 20 may be the application server 100 or the mobile device 120 shown in FIG. 1. The communication device includes a processor 200, such as a microprocessor or an application-specific integrated circuit (ASIC), a storage unit 210 and a communication interface unit 220. The storage unit 210 may be any data storage devices for storing the program code 214 for the processor 200 to access with. For example, the storage unit 210 may be a subscriber identity module (SIM), a read-only memory (ROM), a random-access memory (RAM), CD-ROMs, magnetic tapes, a hard disks or optical data storage devices, and not limited to the mentioned storage devices. The communication interface unit 220 may be a wireless transceiver for exchanging wireless signals between the communication device 20 and the corresponding communication device, according to the processing result of the processor 200.

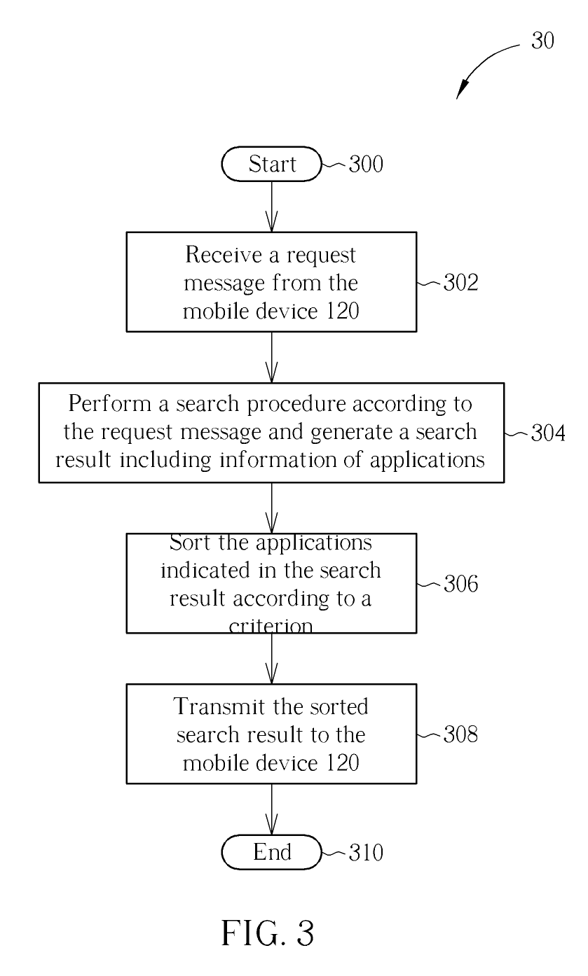

Please refer to FIG. 3, which is a flow chart of an exemplary process 30. The process 30 is used for performing applications sorting for the application server 100 of the wireless communication system 10. The process 30 can be compiled into the program code 214 and includes the following steps:

Step 300: Start.

Step 302: Receive a request message from the mobile device 120.

Step 304: Perform a search procedure according to the request message and generate a search result including information of applications.

Step 306: Sort the applications indicated in the search result according to a criterion.

Step 308: Transmit the sorted search result to the mobile device 120.

Step 310: End.

According to the process 30, the application server 100 receives the request message transmitted from the mobile device 120. The request message is used for requesting the user-interested applications on the application server 100. The application server 100 performs the search procedure according to the search request message and generates the search result which includes information of the searched, user-interested applications. After the search result is generated, the application server 100 sorts the applications indicated in the search result according to a criterion. The criterion may be included in the request message or defined by the application server 100. Preferably, the criterion may include at least one of a price, date, download times and a feedback rating. In other words, after the application server 100 generates the search result, the application server 100 sorts the searched applications according to at least one of a price, date, download times and a feedback rating. Or, when the request message does not include the criterion, the application server 100 may sort the searched applications according to a criterion defined by the application server 100 instead. Then, the application server 100 transmits the sorted search result to the mobile device 120.

For example, the user may search games through the mobile device 120, and expect that the games are sorted according to a feedback rating. The mobile device 120 transmits the request message including a criterion of feedback rating to the application server 100, so as to search games offered by the application server 100. After the application server 100 received the request message, the application server 100 performs the search procedure and generates the search result including information of user-interested games. Then, the application server 100 sorts the games indicated in the search result according to the feedback rating, e.g. rearrange the search result (information of games) by an order that is from the most recommended game to the last recommended one, and transmits the sorted search result to the mobile device 120. As a result, the user can search related applications according to the self-defined criterion with ease.

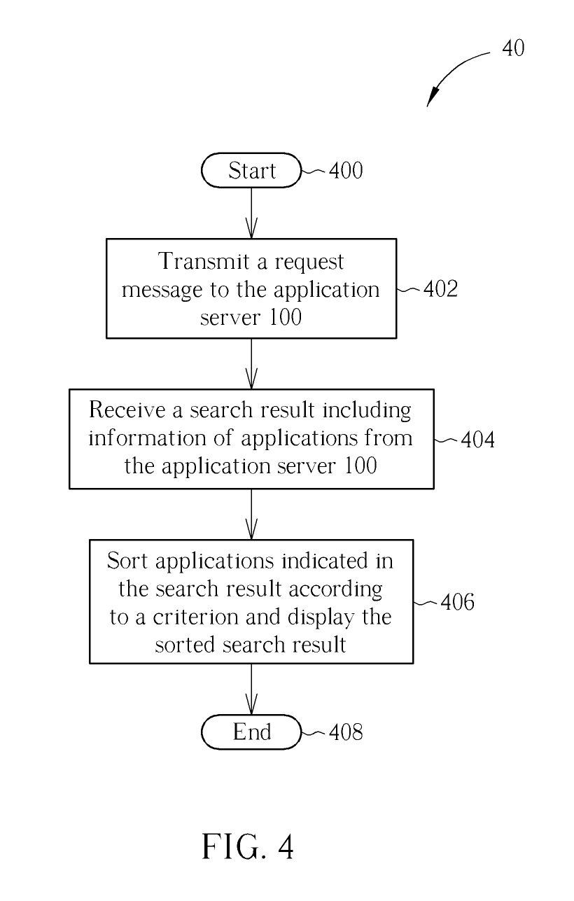

Please refer to FIG. 4, which is a flow chart of an exemplary process 40. The process 40 is used for performing applications sorting for the mobile device 120 of the wireless communication system 10. The process 40 can be compiled into the program code 214 and includes following steps:

Step 400: Start.

Step 402: Transmit a request message to the application server 100.

Step 404: Receive a search result including information of applications from the application server 100.

Step 406: Sort applications indicated in the search result according to a criterion and display the sorted search result.

Step 408: End.

According to the process 40, the mobile device 120 transmits the request message to the application server 100. The request message is used for requesting the user-interested applications in the application server 100. Then, the mobile device 120 receives a search result including information of user-interested applications from the application server 100, and sorts the applications indicated in the search result according to the criterion. The criterion may be defined by the user of the mobile device 120, which includes at least one of a price, date, download times and a feedback rating. Afterward, the mobile device 120 displays the sorted search result.

For example, the user may search games through the mobile device 120. The mobile device 120 transmits the request message to the application server 100, so as to search the games offered by the application server 100. After the application server 100 receives the request message, the application server 100 performs the search procedure, generates the search result including information of games, and transmits the search result to the mobile device 120. If the user expects that the mobile device 120 displays the games according to download times, the user can control the mobile device 120 to rearrange the games indicated in the search result according to download times and displays the sorted search result. As a result, the user can search related applications according to self defined criterion with ease.

Please note that the abovementioned steps including suggested steps can be realized by means that could be hardware, firmware known as a combination of a hardware device and computer instructions and data that reside as read-only software on the hardware device, or an electronic system. Examples of hardware may include analog, digital and mixed circuits known as microcircuit, microchip, or silicon chip. Examples of the electronic system can include system on chip (SOC), system in package (Sip), computer on module (COM), and the communication device 20.

To sum up, the mobile device transmits the request message to the application server, so as to request the application server searching the related applications. After the application server generates the search result, the present invention can re-sort the search result according to user preference, such as a price, date, download times and a feedback rating. As a result, the user can search related applications according to self defined criterion easily.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of sorting applications for a server, the method comprising:
receiving a request message;
performing a search procedure according to the request message and generating a search result including information of applications; and
sorting the applications indicated in the search result according to a criterion.

2. The method of claim 1, wherein the criterion comprises at least one of a price, a date, download times and a feedback rating.

3. The method of claim 1, wherein the criterion is included in the request message or defined by the server.

4. The method of claim 1, further comprising:
transmitting the sorted applications to a mobile device.

5. The method of claim 1, wherein the server is used for Open Mobile Alliance (OMA).

6. A method of sorting applications for a mobile device, the method comprising:
receiving a search result including information of applications from a server; and
sorting the applications indicated in the search result according to a criterion, and displaying the sorted search result.

7. The method of claim 6, wherein the criterion comprises at least one of a price, a date, download times and a feedback rating.

8. The method of claim 6, the criterion is defined by a user of the mobile device.

9. The method of claim 6, further comprising:
transmitting a request message to the server to request the server to perform a search procedure such that the server generates the search result.

10. The method of claim 6, wherein the server and the communication device are used for Open Mobile Alliance (OMA).

11. A server for performing applications sorting, the server comprising:
a storage unit, for storing a program code corresponding to a processing method; and
a processor, coupled to the storage unit, for processing the program code to perform the processing method;
wherein the processing method comprises:
receiving a request message;
performing a search procedure according to the request message and generating a search result including information of applications; and
sorting the applications indicated in the search result according to a criterion.

12. The server of claim 11, wherein the criterion comprises at least a price, a date, download times and a feedback rating.

13. The server of claim 11, wherein the criterion is comprised in the request message or defined by the server.

14. The server of claim 11, wherein the processing method further comprises:
transmitting the sorted search applications to a communication device.

15. The server of claim 11, wherein the server is used for Open Mobile Alliance (OMA).

16. A communication device for performing applications sorting, the communication device comprising:
a storage unit, for storing a program code corresponding to a processing method; and
a processor, coupled to the storage unit, for processing the program code to perform the processing method;
wherein the processing method comprising:
receiving a search result including information of applications from a server; and
sorting the applications indicated in the search result according to a criterion, and displaying the sorted search result.

17. The communication device of claim 16, wherein the criterion comprises at least a price, a date, download times and a feedback rating.

18. The communication device of claim 16, wherein the criterion is defined by the communication device.

19. The communication device of claim 16, wherein the processing method further comprises:
transmitting a request message to the server to request the server to perform a search procedure such that the server generates the search result.

20. The communication device of claim 16, wherein the server and the communication device are used for Open Mobile Alliance (OMA).
